(19) United States
(12) Patent Application Publication
(10) Pub. No.: US 2011/0024988 A1
(43) Pub. Date: Feb. 3, 2011

(54) METHOD OF SEALING A LEAK

(76) Inventors: Nicholas John Ryan, Aberdeen (GB); Andrew James Cochran, Aberdeen (GB)

Correspondence Address: WINSTEAD PC, P.O. BOX 50784, DALLAS, TX, 75201, US

(21) Appl. No.: 12/921,884

(22) PCT Filed: Mar. 12, 2009
(86) PCT No.: PCT/GB2009/050241

§ 371 Date: Oct. 14, 2010

(30) Foreign Application Priority Data
Mar. 12, 2008 (GB) 0804566.8`

(51) Int. Cl. F16J 15/40

(52) U.S. Cl. 277/316; 277/627

(57) ABSTRACT

The present invention relates to a method of sealing a leak, comprising 5 introducing a sealing mixture to a leak site, the sealing mixture comprising at least one elastomeric sealing element and a non-Newtonian fluid. The present invention also relates to sealing mixtures comprising at least one elastomeric sealing element and a non-Newtonian fluid.

### FIELD OF INVENTION

The present invention relates to a method of sealing a leak. In particular but not exclusively, the present invention relates to a method of reducing or stopping seepage through a leak in a vessel, valve, pipe or duct. More particularly, but not exclusively, the present invention relates to such methods when used in industries involved with hydrocarbons. The invention also relates to sealing mixtures.

### BACKGROUND OF THE INVENTION

The present Applicant has for many years been developing techniques for sealing and stemming leaks from ducts carrying, for example, hydrocarbons.

The Applicant's patent application WO-A-01/86191 discloses a plurality of elements, each in the form of a membrane, which are introduced into a duct to be carried along the duct by the flow of the fluid therein. At the locality of the leak, at least one of the sealing elements is captured by a pressure differential associated with the leak and is thereby drawn to and held in position at the leak for stemming or sealing it.

The Applicant's patent application WO-A-03/93713 discloses introducing a plurality of sealing elements into a duct which have an effective size less than the effective size of the leak. Even though the pressure differential attributable to the leak is relatively small, the sealing elements are drawn to, move over and build up with the duct at the leak and reduce seepage therefrom.

As discussed in these two applications, through the techniques disclosed, it is possible to reduce or eradicate the problems associated with leakage from ducts which are inaccessible or only accessible with considerable difficulty.

However, a problem remains with the techniques disclosed in the aforesaid two applications in that the sealing element(s) often do not make a complete seal at the leak so as to completely stop leakage therefrom. In particular, unless the individual sealing element or multiple sealing elements in combination perfectly occlude the leak, flow routes can remain around the sealing elements by which fluid in the duct can continue to leak to the outside of the duct.

Moreover, in the hydrocarbon industry there are particular safety constraints which often require a double seal barrier between the hydrocarbon carrying duct and the external environment. If there is then a small leak, even though the volume leakage of hydrocarbon due to seepage may be relatively small, i.e. a trickle leakage flow, it is nevertheless important that such leaks are completely sealed for health and safety reasons or for environmental reasons. In addition, leak development and leak appearance is a dynamic process and the techniques disclosed in the aforesaid two applications do not provide a way of sealing such leaks.

The present invention seeks to provide a method for overcoming the aforementioned disadvantages of the prior art and provide an improved method of reducing or completely sealing leaks.

### SUMMARY OF THE INVENTION

In a first aspect, the present invention relates to a method of sealing a leak comprising the step of introducing a sealing mixture to the leak site, the sealing mixture comprising at least one elastomeric sealing element and a non-Newtonian fluid.

Optionally, the at least one sealing element is in suspension in the sealing mix.

Preferably, the fluid flows in response to shear forces acting on the fluid.

Conveniently, flow of the fluid draws the at least one sealing element to the leak site.

In one embodiment, shear forces acting upon the fluid and/or the at least one sealing element deforms the sealing element at the leak site to form a seal. Conveniently, the pressure of the non-Newtonian fluid, or any other fluid present at the leak site, transmits shear forces to the at least one sealing element to deform the at least one sealing element. Preferably, the deformed at least one sealing element at the leak site forms a tight seal to seal the leak.

Preferably, the sealing mixture forms a matrix at the leak site.

Optionally, the apparent viscosity of the fluid at the leak site increases in response to reduced shear forces acting on the fluid at the leak site.

Preferably, the increased apparent viscosity of the fluid at the leak site prevents fluid flow at the leak site.

Conveniently, the fluid may remain in the seal formed at the leak site.

Preferably, the fluid does not set at the leak site.

Conveniently, the seal may be maintained by pressure exerted by the fluid onto the at least one sealing element. Preferably, pressure exerted by the fluid onto the at least one sealing element maintain a seal in response to a conformational change in the leak site

Preferably, the sealing mixture forms a flexible barrier or dynamic seal which can immediately and rapidly reform and renew itself in response to a conformational change in the leak site without any further leaking from the leak site.

Conveniently, the sealing mixture may comprise more than one non-Newtonian fluid.

Optionally, the non-Newtonian fluid may be selected from the group consisting of a Bingham plastic, a pseudoplastic, a high viscosity fluid, a thixotrophic fluid or a viscosified liquid.

Preferably, the fluid is a grease. Optionally, the grease is an oil based grease. Conveniently, the grease may be a mineral-oil based grease or a silicone grease.

Optionally, the viscosified liquid is a polymer viscosifier, such as but not limited to guar gum, xanthium gum and cross-linked viscosifiers.

In one embodiment, the sealing mix comprises a plurality of sealing elements.

Preferably, the sealing mixture comprises a range of different sized sealing elements. The sealing elements may be in the size range of 50 mm to 1pm, but smaller or larger sealing elements may be used if required. Optionally, the sealing elements are in the size range of 10 to 500 μm. Preferably, the sealing elements are in the size range of 1pm to 595 μm. Particularly suitably sized sealing elements may be, but are not limited to, 1 mm, 2 mm, 3 mm, 4 mm, 5 mm,6 mm, 600-1000 μm, 595 μm or less (30s mesh), 200 μm or less (72s mesh), 120 μm, 125 μm or less (120s mesh). Mixtures of these sized sealing elements in a sealing mixture are also particularly preferred. In particular sealing mixtures including equal parts of 600-1000 μm, and 30s mesh and 72s mesh, or equal parts of 72s mesh and 30s mesh are preferred.

In another embodiment, the sealing mixture comprises at least one sealing element coated with a non-Newtonian fluid.

Conveniently, a sealing mixture including sealing elements coated with the non-Newtonian fluid may be introduced remotely to the leak site.

Optionally, the remotely administered sealing mixture may be administered in a container, e.g. a bag.

Additionally, sealing elements coated with a non-Newtonian fluid may further be suspended in a second fluid, the second fluid being immiscible in any fluid flowing through or past the leak site and wherein the coated sealing elements are drawn to the leak site by flow of the second fluid.

Optionally, the second fluid may be a Newtonian fluid, e.g. water, or a non-Newtonian fluid.

In a further embodiment, the present invention relates to a method of sealing a leak in accordance with the first aspect of the invention, the method further comprising the step of subsequently introducing at least one additional sealing mixture to the leak site.

In one embodiment, a plurality of additional sealing mixtures are subsequently introduced to the leak site in a sequential manner.

Optionally, each of the additional sequentially introduced sealing mixtures comprises sealing elements of a different size than a preceding sealing mixture.

Preferably, each of the sequentially introduced sealing mixtures comprises sealing elements of a smaller size than a preceding sealing mixture.

Optionally, at least one of the additionally sequentially introduced sealing mixtures comprises a sealing mixture where the sealing elements are coated with the non-Newtonian fluid.

Conveniently, the sealing elements may comprise an elastomer, silicone rubbers, polyurethane rubbers, natural rubbers, nitrile rubbers and/or a flouropolymer elastomer.

The sealing elements may be formed into a shape corresponding to any one of planar-oblong, cubes, spheres, pyramids, octahedrons, tetrahedrons, thistle-seed shaped, filament shaped or of an irregular shape.

Conveniently, the sealing mixture comprises 1% to 50% sealing elements by weight, preferably 1 to 30% by weight.

In one embodiment, the leak is a leak in a valve, pipe, vessel, o-ring or a duct, although as would be appreciated by the person skilled in the art, the methods of the present invention may be used to seal any leak, such as but not limited to remediation of seal failure, tubing joints, pig launcher/receiver, hydrants, heat exchangers and glands

In another embodiment, the sealing mixture comprises at least one sealing element which has been coated with a non-Newtonian fluid.

In a second aspect, the present invention relates to a sealing mixture comprising a non-Newtonian fluid and at least one elastomeric sealing element

In a third aspect, the present invention relates to a method for sealing a leak, the method comprising:
forming a plurality of sealing elements, wherein the sealing elements are formed to have selected parameters;
producing a sealing mixture by adding the sealing elements to a substance;
filling the vessel with the sealing mixture;
characterised in that the substance has its rheological properties selected to suspend the sealing elements within the sealing mixture;
the rheological properties of the substance are further selected such that flow of the substance occurs in response to shear forces acting thereon from a pressure differential at the locality of the unsealed leak;
the parameters of the sealing elements are selected such that one or more sealing elements are drawn to the leak by the flow of the substance occurring in response to said shear forces and are held in position at the leak for stemming or sealing it; and
the rheological properties of the substance are further selected such that flow of the substance does not occur as said shear forces reduce as the pressure differential at the locality of the leak reduces consequent to the one or more sealing elements being held in position at the leak.

With the above method, by selecting appropriate rheological properties for the substance, a complete seal can be provided to seal a leak in the vessel.

Preferably the sealing mixture contains 1% to 50% sealing elements by weight.

In a fourth aspect, the present invention relates to a method for reducing or stopping seepage through a leak in a duct along which a liquid is flowing, the method comprising:
forming a plurality of sealing elements, wherein the sealing elements are formed to have selected parameters;
coating the sealing elements with a substance; and introducing the plurality of coated sealing elements into the duct;
   characterised in that the parameters of the sealing elements are selected such that the plurality of coated sealing elements are transported along the duct by the liquid and, at the locality of the leak, one or more coated sealing elements are captured by a pressure differential associated with the leak and are thereby drawn to and held in position at the leak for stemming or sealing it;
   the substance has its rheological properties selected such that flow of the substance occurs in response to shear forces acting thereon due to said pressure differential; and;
   the rheological properties of the substance are further selected such that flow of the substance does not occur as said shear forces reduce as the pressure differential at the locality of the leak reduces consequent to the one or more sealing elements being held in position at the leak.

With the above method, by selecting appropriate rheological properties for the substance, a complete seal, or a much improved seal, can be provided to seal a leak in the duct.

Preferably the vessel or duct is associated with a particular liquid and the substance and sealing elements are chosen to be inert to exposure to the particular liquid.

Preferably the sealing elements are elastomeric particles.

Preferably the sealing elements are in the size range 1 mm to 1 pm.

More preferably the sealing elements are in the size range 10 to 500 μm.

Preferably the substance is an oil-based grease. More preferably the oil-based grease is silicone grease.

The present invention also encompasses a sealing element for use in the above-described method.

As would be understood by the person skilled in the art, any of the above features, aspects and embodiments of the present invention may be independently added or interchanged with any other feature, aspect or embodiment of the present invention.

Examples of the present invention will now be described in detail with reference to the accompanying drawings, in which:

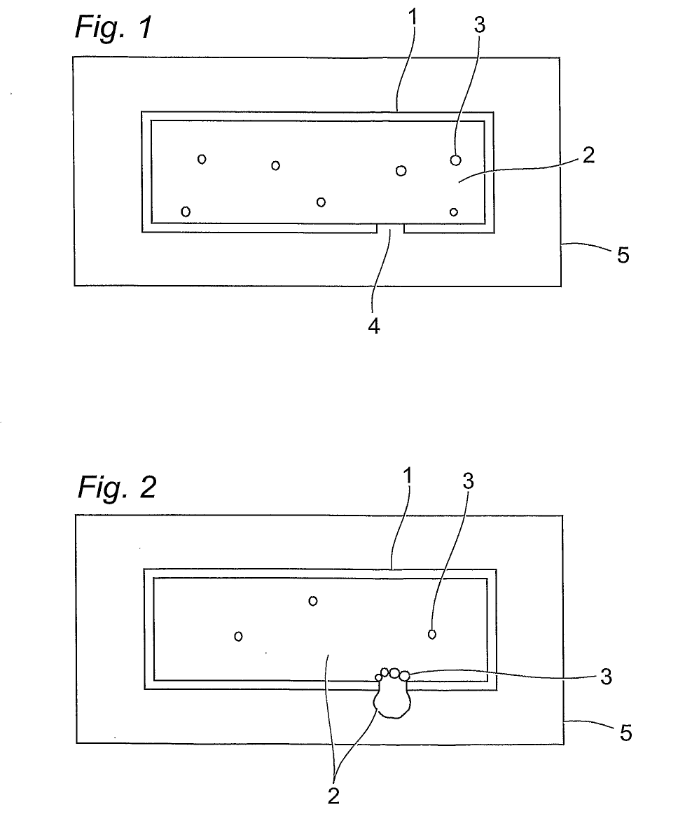

FIG. 1 illustrates, schematically, an enclosed environment adjacent another environment just after filling with a sealing mixture;

FIG. 2 illustrates the response of sealing elements in the sealing mixture following the filling of the enclosed environment of FIG. 1 with the sealing mixture;

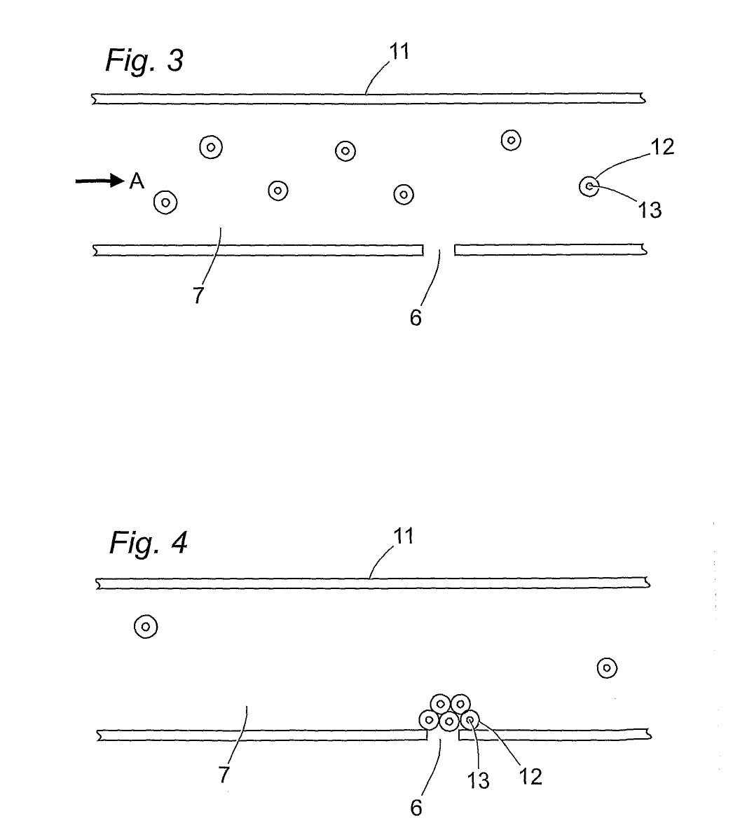

FIG. 3 illustrates a liquid carrying duct to which coated sealing elements have been added;

FIG. 4 illustrates the movement of the coated sealing elements in the duct of FIG. 3 in the locality of a defect.

### DETAILED DESCRIPTION OF THE INVENTION

FIG. 1 depicts use of generally spherical elastomeric sealing elements. However, any shaped sealing element may be used, as discussed below.

The sealing elements of elastomeric material are made from ground natural rubber and styrene butadiene compound and have dimensions ranging from 10 to 500 μm. However, as discussed below, other materials and sizes of sealing elements may be used depending on the location and size of the leak or defect.

A sealing mixture may be produced by mixing sealing elements 3 with a non-Newtonian fluid 2. The non-Newtonian fluid may be selected to have particular rheological properties to enable the fluid to flow within any substance or fluid which may be leaking through the leak site. In FIG. 1, fluid 2 is depicted as comprising a silicone grease 2 which has an “apparent viscosity” of 60,000 centipoise (cP) (=60 Pa.) at 25° and standard pressure. “Apparent viscosity” is used to represent the viscosity of a material which may not ordinarily flow but can flow with applied force, and which therefore has a changeable viscosity with respect to the force applied. The sealing elements 3 and grease 2 are mixed together in a ratio of 1:9 by mass.

FIG. 1 illustrates, schematically, an enclosed environment 1, representative of a sealed environment, adjacent another environment 5, for example a hydrocarbon carrying line. The closed environment 1 has a pin-hole defect 4 of approximately 15 μm at its largest diameter which communicates with the adjacent environment 5 resulting in a leak between the two.

The sealing mixture is introduced into the closed environment 1, the sealing mixture including the sealing elements 3 and grease 2. The sealing mixture is introduced into the closed environment such that it is at a positive pressure relative to the adjacent environment 5. Thus, at the locality of the defect 4, there is a pressure differential through which the content of the closed environment 1 can leak into the adjacent environment 5. This pressure differential applies a shear force which acts on the sealing mixture.

The rheological property of the fluid 2 is selected such that in the particular case the pressure differential resulting from the defect 4 is sufficient to cause a shear force sufficient for, in this case the grease 2, to flow through the defect 4. As a result of this flow, one or more of the close-by sealing elements 3 is drawn to the defect 4 where a sealing element will completely span the leak, or partially span the defect such that further sealing elements are drawn to the leak and hence build up over the defect as shown in FIG. 2.

In some instances dependent on the particular environment, the elastomeric sealing elements may enter the leak site or be partially extruded through the leak site in order to seal the leak.

As the defect 4 becomes occluded, the pressure differential resulting there from reduces, as does the corresponding shear force acting on the grease 2. Eventually, a point is reached where the shear force is insufficient to cause flow. When this occurs, the grease 2 becomes effectively immovable and hence fills any space between the sealing element(s) 3 and the defect 4 such that a complete seal is provided. Consequently, the non-Newtonian fluid remains in the seal formed at the leak site. It will be further appreciated that as the sealing elements 3 are made of elastomeric material, any movement thereof is transmitted by the grease 2 to any adjacent sealing element such that the sealing elements can settle at the defect producing a better fit to the shape thereof and a better seal between the environments 1 and 5.

Additionally, forces acting upon the sealing elements may result in deformation of the sealing elements allowing a tighter or more closely packed seal to be formed. The forces acting upon the sealing elements may result from the pressure of the non-Newtonian fluid within the sealing mixture and/or may result from the pressure of any other fluid or substance at the location of the leak site. For example, where the leak site is in a vessel or a pipeline, fluids within the vessel or pipeline may act upon the non-Newtonian fluid of the sealing mixture and/or the sealing elements to cause deformation of the sealing elements.

Moreover, in the event that the defect 4 changes, for example through corrosion, further movement of the sealing elements 3 can occur to accommodate this change. As such, the seal formed at the defect 4 represents a flexible barrier or a dynamic seal which can immediately and rapidly reform and renew itself to prevent any further leakage from the defect, i.e. in other words, the seal formed in accordance with the present invention is “self-healing”, resealing itself in response to a conformational change at the defect or leak site.

In addition, by suitable choice of the rheological properties of the fluid 2, the elastomeric particles 3 are effectively held in suspension within the grease almost indefinitely whilst the grease remains capable of flow if subjected to the appropriate shear force. Thus, if a new defect appears, the same process of flow of the fluid 2 followed by movement of the sealing elements 3 to the defect 4 can occur, eventually leading to sealing of the new defect.

Alternatively, the mixture can be pumped out of the closed environment 1 whilst maintaining the positive pressure relative to the adjacent environment

It will be appreciated that although the sealing elements of FIGS. 1 and 2 have been described as having a dimension of between 10 to 500 μm, in other embodiments, the sealing elements can be any size. For instance, the sealing elements may have a dimension ranging from 50 mm down to 1 pm, although a dimension of between 10 to 500 μm has been found to be particularly suitable. However, any size or range of sizes of the elastomeric sealing elements may be used in one or multiple sealing mixtures, as described below. For instance, the sealing mixture may comprise sealing elements of any of the following sizes or a mixture of the following sizes: 1 mm, 2 mm, 3 mm, 4 mm, 5 mm, 6 mm, 600-1000 μm, 595 μm, less than 595 μm (30s mesh), 200 μm, less than 200 μm (72s mesh), 120 μm, 125 μm or less than 125 μm (120s mesh). Mixtures of these sized sealing elements in a sealing mixture are also particularly preferred

The sealing elements can also all have identical size or be a mixture of sizes, depending on knowledge of the defect. In some instances, a tighter seal may be formed by using a range of sealing elements in the sealing mixture.

Use of a range of sealing elements enables smaller sealing elements to fit into any spaces between individual sealing elements within or at the leak site, thus forming a sealant matrix comprising fluid within the sealing mixture and multiple sized sealing elements to form a compact seal.

Additionally, forces acting upon both the fluid in the sealing mixture and the sealing elements act to compress sealing elements within the matrix allowing a tighter seal to be formed at the leak site.

The sealing elements can be any suitable elastomer material, such as silicone rubbers, polyurethane rubbers, natural rubbers, nitrile rubbers and fluoropolymer elastomers, are preferred.

In addition, the sealing elements can take the form of a planar oblong element similar to a credit card shape, or can have a variety of geometries including cubes, spheres, pyramids, octahedrons and tetrahedrons, or more aerodynamically shaped elements with higher drag coefficients such as thistle seed shaped elements. Sealing elements may also be filament shaped or of an irregular shape.

It will also be appreciated that the grease 2 can be replaced by any suitable material having the appropriate rheological properties. In this respect rheological properties refers to the elasticity, viscosity and plasticity of the material. Thus, the material should have properties intermediate a liquid and a solid in that it should have the ability to retain its shape and yet assume the properties of a liquid in response to the pressure differential associated with a leak.

Suitable fluids for use in the present invention include, but are not limited to, oils, e.g. mineral oils and greases, such as but not limited to, silicone grease or oil based grease.

In the embodiment depicted in FIGS. 1 and 2, silicone grease was selected because of its high temperature stability and it is inert in relation to hydrocarbons and does not attack standard seals or elastomers encountered in the hydrocarbon industry. It will also be apparent to those skilled in the industry that the closed environment 1 can be considered representative of a closed system such as the test port on a tubing hanger of an oil well, or the ball cavity between the seats of a ball valve.

The exact non-Newtonian fluid or substance used in the methods of the present invention is reliant on the leak site and any other fluid or substance which may be leaking or seeping through the defect or leak site. The non-Newtonian fluid or substance are ideally selected to be inert or as inert as possible in relation to any fluid seeping or present at the defect leak site.

The mix ratio of fluid to sealing element can be chosen according to application, although the range of 1% to 50% sealing elements by weight in grease has been found particularly suitable. Other suitable ranges of sealing elements include 2%, 5%, 7%, 10%,12% 15%, 17%, 20%, 22%, 25%,27%, 30%, 32%, 35%, 37%, 40%, 42% and 45%.

Alternatively, the ratio of sealing elements to non-Newtonian fluid may be calculated on a mass ratio. Ratios of 1:1, 1:2, 1:3, 1:4, 1:5, 1:6, 1:7, 1:8, 1:9, 1:10, 1:12, 1:13, 1:14 and 1:15 may be used, although any other ratio may be used in the methods and compositions of the invention.

The closed environment may be of any size, for example, but not limited to between 0.5 and 500 litres volume.

A second embodiment of the present invention will now be described with reference to FIGS. 3 and 4 where a sealing mixture including a plurality of sealing elements 13 is used. In this embodiment these take the form of particles made from elastomeric materials and have dimensions ranging between 5 to 100 μm.

The sealing elements 13 are then coated with a fluid 12 having particular selected rheological properties. The coating step is performed such that the amount of coating gives the coated sealing elements particular selected properties. In this embodiment the fluid 12 is a mineral-oil based grease 12, which is coated around the sealing elements 13 until the coated sealing elements are capable of being transported through crude oil 7 and further capable of flowing towards a leak by virtue of a pressure differential at a leak site.

The coated sealing elements 13 are then introduced into a duct 11 with crude oil 7 flowing through it in the direction of arrow A, by a suitable means such as an upstream valve, as shown in FIG. 3. The duct 11 has a crack defect 6 of approximately 15 μm along its length, which is in communication with the environment surrounding the duct.

In general, the sealing elements 13 will flow along the duct 11 by virtue of their suspension in the oil 7. At the locality of the defect 6, there is a pressure differential between the oil 7 and the surrounding environment as the oil 7 leaks into the surrounding environment.

The coated sealing elements are drawn to the leak and held in position at the defect. As they are positioned at the defect, the seal is incomplete and there remains a localised pressure differential. As mentioned above, the rheological properties of the grease 12 are selected such that in this particular case, the pressure differential is sufficient to cause flow of the coating of the sealing elements 13 due to the shear force acting thereon.

Thus, the coating can flow out through the defect as well. Nevertheless, as mentioned above, as the defect becomes occluded, the pressure differential resulting therefrom reduces, as does the corresponding shear force acting on the coating 12. Eventually, a point is reached such that the shear force is insufficient to cause flow. In this case, the coating 12 becomes effectively immovable and hence fills any space between the sealing element(s) 13 and the defect 6 such that a complete seal is provided. It will be further appreciated that although the sealing elements 13 are made of elastomeric material, any movement thereof is transmitted by the coating 12 to any adjacent sealing element such that the sealing elements can settle at the defect producing a better fit to the shape thereof and a better seal. Moreover, in the event that the defect 6 changes, for example through corrosion, further movement of the sealing elements 13 can occur to accommodate this change. Thus, as noted above, the seal formed is a flexible barrier or dynamic seal which upon any alteration to the defect or leak site can rapidly reform and renew itself so that any further leakage is prevented.

In a non-illustrated embodiment, the coated sealing elements may be suspended in a second fluid, which can be a non-Newtonian fluid. Flow of the non-Newtonian fluid carries the coated sealing elements to the leak site. The second fluid is preferably immiscible with any other fluid present at the leak site.

The coated sealing elements may be introduced to the vessel etc containing the leak at a remote position. The remotely introduced coated sealing elements may be transported to the leak site in a dispenser or container such as a bag, or a downhole tool, such as but not limited to, Pigs, pistons or isolation tools such as a pipeline isolation tool

In another (non-illustrated) embodiment, more than one sealing mixture may be used to seal a leak. Preferably a series of sequentially added sealing mixtures are used to enable the formation of a tight seal or to ensure a large seal is sealed quickly.

As many sequentially added sealing mixtures as needed may be added until the leak is sealed. Each of the sequentially added sealing mixtures can include sealing elements of decreasing size to sequentially fill small spaces remaining within the seal. Alternatively, each of the sequentially added sealing mixtures can include similar sized sealing elements.

Additionally, each of the sequentially added sealing mixtures may comprise a range of sizes of sealing elements or more than one size of sealing element. The sealing elements may range greatly in size or may be very similar in size. Alternatively, each of the sealing mixtures may include only one sized sealing element.

Further, an additionally sequentially added sealing mixture may comprise a sealing mixture where the sealing particles are coated by the non-Newtonian fluid.

When formed, the matrix sealing the leak site includes multiple sealing elements and represents a flexible barrier or a dynamic seal which can immediately and rapidly reform and renew itself to prevent any further leakage from the leak site. In embodiments where the sealing mixture includes a range of different sized sealing elements, or where a plurality of sealing mixtures are used with each sealing mixture including a range of sealing element sizes, or a different size of sealing element compared to a preceding sealing mixture, then the matrix includes a range of different sized sealing elements. In this instance, the smaller sealing elements fill any spaces formed between larger sealing elements to provide a tight seal.

In another non-illustrated embodiment, the sealing elements form a sealing mixture with a thixotropic fluid which at least partially sets in the leak site to form a permanent seal.

In a further non-illustrated embodiment, the sealing mixture further includes a pressure activated adhesive which may be coated onto the sealing elements. The sealing mixture is introduced to the leak site in accordance with the methods of the present invention and once at the leak site, the pressure transmitted to the sealing elements activates the adhesive. The adhesive glues the sealing elements to the leak site to allow a permanent seal to be formed. Depending on the location of the leak site, any non-adhered sealing elements may be flushed from the leak site if required. Suitable pressure activated adhesives are known to the person skilled in the art. Agents which promote chemical bonding may also be included, and include but are not limited to titanate.

As will be understood by the person skilled in the art, the examples illustrated show applications of the invention only for the purposes of illustration. In practice the invention may be applied to many different configurations, the detailed embodiments being straightforward for those skilled in the art to implement.

For example the invention is equally applicable to many types of valve systems, and any kind of pipework such as water-carrying pipework.

As used herein, the term “non-Newtonian fluid” is taken to mean all for which the viscosity varies with the shear rate. The viscosity of a non-Newtonian fluid is the ratio of sheer stress to shear rate and is termed the apparent viscosity. The non-Newtonian fluid of the invention is non-Newtonian when in use in the methods of the present invention, but may act as a Newtonian fluid at other times.

As used herein, the term “non-Newtonian fluid” includes, but is not limited to, Bingham plastics or fluids (or solids), pseudoplastics, dilatant fluids, high viscosity fluids or viscosified liquids.

A dilatant fluid is taken to mean a fluid which when stressed increases its resistance to further stress by increasing its shear rate, i.e increasing its apparent viscosity.

A pseudoplastic is taken to mean a substance or fluid which acts in the opposite way to a dilatant fluid, i.e. a fluid where apparent viscosity falls with increasing sheer rate.

A Bingham plastic is taken to mean a material which shows little tendency to flow until a critical stress is reached and may include a dilatant or pseudoplastic material.

Thixotropic fluids may also be used in the methods and sealing elements of the present invention. A thixotropic fluid is taken to mean a fluid for which the viscosity reduces in response to applied stress and increases viscosity in response to reduced stress. For example, the fluid may be a gel at rest but may become liquid when shaken or stirred.

As used herein, the terms leak site and defect are used interchangeably and are taken to mean any site at which unwanted seepage or leaking may occur.

Modifications and deviations from the invention may be envisaged without departing from the scope of the invention. Furthermore, aspects of any specific embodiment disclosed herein may be used independently in another aspect or embodiment of the invention as herein described.

Additionally, any sealing mixture described above may include sealing elements formed into one or more shapes of the same, similar or different sizes, or in a range of sizes.

As would be appreciated by the person skilled in the art, the methods and compositions of the present invention may be used to seal any leak or defect. In particular, but not exclusively, the methods and compositions of the present invention may be used to seal a leak or defect in a valve, pipe line, seal, vessel, duct, tubing and tubing joints e.g. pipe dope, and o-rings which have failed, remediation of a seal failure, a pig launcher/receiver, a hydrant, a heat exchanger or a gland.

The methods and sealing mixtures of the present invention are suitable for use in a well bore. For instance, the methods and sealing mixtures of the present invention may be used to reduce fluid losses during drilling and closing water production zones.

When used to reduce drilling losses, the sealing mixture may be introduced through a drill pipe. Preferably, a range of different sized sealing elements are introduced to enable sealing of variable fractures and thief zones. The sealing mixture may be provided in the form of a gel which is deposited at selected locations throughout the drill pipe. After the fracture or thief zone has been sealed, hydrostatic forces exerted by the fluid filling the well can act to keep the sealing mixture in place. In this application of the methods and sealing mixtures of the present invention only a temporary seal is required as once drilling progresses, a casing may be used to seal off the fracture or thief zone. However, as would be appreciated by the person skilled in the art, the methods and sealing mixtures of the present invention may be used in any application to form a permanent seal if desired.

When used during water shut off procedures, the sealing mixture may include sealing elements comprised of an elastomeric material which swells in water and/or the sealing mixture may include sealing elements which dissolve in oil but are inert (i.e. do not dissolve) in water. The sealing mixture of the present invention is introduced to the well bore and carried to the water shut off point or pore throat with pressure of the fluids forcing the platelets into the formation or pore throat. In this embodiment, the sealing mixture may be provided in the form of a gel.

The methods and sealing mixtures of the present invention may also be used to seal leaks in an annulus or leaks between concentric annuli, e.g. A to B to C annulus leaks, or leaks in a pipe in pipe situation, leaks in sand control screens, leaks in control lines during completion of a well, and leaks in subsurface safety valves (SSSVs) and surface-controlled subsurface safety valves (SCSSVs).

The methods and sealing mixtures of the present invention are also suitable for use within the water and gas industries, both in a commercial and a municipal setting. For instance, the methods and sealing mixtures of the present invention could be used to seal leaks present in any part of the infrastructure associated with wastewater capture, transportation, storage and treatment, raw water capture, transportation, delivery and storage and potable water treatment, storage, capture, transportation and delivery, and brackish and desalinated water capture, treatment, transportation, delivery and storage.

Additionally, the methods and sealing mixtures of the present invention are suitable for use in sealing leaks in or at any point within the infrastructure associated with irrigation systems and the treatment, storage, capture and transportation and delivery of fluids through irrigation systems.

Furthermore, the methods and sealing mixtures of the present invention are suitable for use in sealing leaks within delivery, storage, treatment and capture of gas, e.g. natural gas. The methods and sealing mixtures of the present invention may also be used seal leaks in carbon capture and storage systems.

Moreover, the sealing mixture of the present invention may be used during assembly of a tool, e.g. a completion tool, to lubricate any seals or valves within the tool, thereby providing a reservoir of sealing mixture within the assembled tool. Thus, if a leak occurs in the tool at the site of a seal or a valve, the sealing mixture of the present invention is already in place to seal the leak.

Conveniently, grease injection systems known to the skilled man may be used to introduce the sealing mixture of the present invention to a desired location.

Additionally, any suitable means of measuring the pressure across the seal formed by the sealing mixture at the leak site, or the volume of the seal at the leak site may be used in accordance with the methods of the present invention to allow condition monitoring of the seal.

Condition monitoring of the seal allows any degradation of the seal to be measured and thus failure of the seal to be pre-empted. In this event, further sealing mixture may be added to the seal to bolster seal integrity. If condition monitoring is via pressure, a drop in pressure measured at the seal would indicate that there is degradation of the seal. Pressure at the seal may be measured by a pressure gauge. Further, in order to maintain pressure at a seal formed in accordance with the methods and sealing mixtures of the present invention, an accumulator may be provided to apply a pressure charge to the seal.

If volume of the seal is measured to allow condition monitoring then a decrease in seal volume indicates an increase in seal degradation.

1. A method of sealing a leak comprising the step of:
introducing a sealing mixture to the leak site, the sealing mixture comprising:
at least one elastomeric sealing element; and
a non-Newtonian fluid.

2. A method as claimed in claim 1, wherein the at least one sealing element is in suspension in the sealing mixture.

3. A method as claimed in claim 1, wherein the fluid flows in response to shear forces acting on the fluid.

4. A method as claimed in claim 1, wherein flow of the fluid draws the at least one sealing element to the leak site.

5. A method as claimed in claim 1, wherein shear forces acting upon at least one sealing element deforms the at least one sealing element at the leak site to form a seal.

6. A method as claimed in claim 5, wherein pressure of the non-Newtonian fluid transmits shear forces to the at least one sealing element to deform the at least one sealing element.

7. A method as claimed in claim 5, wherein deformed sealing elements at the leak site form a tight seal to seal the leak.

8. A method as claimed in claim 1, wherein the sealing mixture forms a matrix at the leak site.

9. A method as claimed in claim 1, wherein an apparent viscosity of the fluid at the leak site increases in response to reduced shear forces acting on the fluid at the leak site.

10. A method as claimed in claim 9, wherein the increased apparent viscosity of the fluid at the leak site prevents fluid flow at the leak site.

11. A method as claimed in claim 1, wherein the fluid remains in the seal formed at the leak site.

12. A method as claimed in claim 1, wherein the fluid does not set at the leak site.

13. A method as claimed in claim 1, wherein the seal is maintained by pressure exerted onto the at least one sealing element by the fluid.

14. A method as claimed in claim 1, wherein pressure exerted by the fluid onto the at least one sealing element maintains the seal in response to a conformational change in the leak site.

15. A method as claimed in claim 1, wherein the sealing mixture forms a flexible barrier or dynamic seal which immediately and rapidly reforms and renews in response to a conformational change in the leak site without any further leaking from the leak site.

16. A method as claimed in claim 1, wherein the sealing mixture comprises more than one non-Newtonian fluid.

17. A method as claimed in claim 1, wherein the non-Newtonian fluid comprises a Bingham plastic, a pseudoplastic, a high viscosity fluid, a thixotropic fluid or a viscosified fluid.

18. A method as claimed in claim 1, wherein the fluid comprises a grease.

19. A method as claimed in claim 18, wherein the grease is an oil based grease selected from the group consisting of a mineral-oil based grease and a silicone grease.

20. A method as claimed in claim 17, wherein the viscosified fluid comprises a polymer viscosifer selected from the group consisting of guar gum, xanthium gum and cross linked viscosifiers.

21. A method as claimed in claim 1, wherein the sealing mixture comprises a plurality of sealing elements.

22. A method as claimed in claim 21, wherein the sealing mixture comprises a range of different sized sealing elements.

23. A method as claimed in claim 22, wherein the sealing elements are in the size range of 50 mm to 1 pm.

24. A method as claimed in claim 23, wherein the sealing elements are in the size range of 1000 μm to 1 pm.

25. A method as claimed in claim 24, wherein the sealing elements are in the size range of 595 μm to 1 pm.

26. A method as claimed in claim 25, wherein the sealing elements are in the size range of 120 μm to 1 pm.

27. A method as claimed in claim 1, wherein the sealing mixture comprises at least one sealing element coated with a non-Newtonian fluid.

28. A method as claimed in claim 27, wherein the sealing mixture is remotely introduced to the leak site.

29. A method as claimed in claim 28, wherein the sealing mixture is remotely introduced to the leak site in a container.

30. A method as claimed in claim 27, wherein the non-Newtonian fluid is immiscible with any other fluid present at the leak site.

31. A method as claimed in claim 27, wherein the coated sealing elements are in suspension in a second fluid.

32. A method as claimed in claim 1, further comprising the steps of subsequently introducing at least one additional sealing mixture to the leak site.

33. A method as claimed in claim 32, wherein a plurality of additional sealing mixtures are subsequently introduced to the leak site in a sequential manner.

34. A method as claimed in claim 32, wherein each of the additional sequentially introduced sealing mixtures comprise sealing elements of a different size than a preceding sealing mixture.

35. A method as claimed in claim 32, wherein each of the additional sequentially introduced sealing mixtures comprises sealing elements of a smaller size than a preceding sealing mixture.

36. A method as claimed in claim 32, wherein the additional sequentially introduced sealing mixture comprise sealing elements coated with a non-Newtonian fluid.

37. A method as claimed in claim 1, wherein the sealing elements comprise any one of silicone rubbers, polyurethane rubbers, natural rubbers, nitrile rubbers or a fluoropolymer elastomer.

38. A method as claimed in claim 1, wherein the sealing elements are formed into a shape corresponding to any one of planar-oblong, cubes, spheres, pyramids, octahedrons, tetrahedrons, thistle-seed shaped, filament shaped or of an irregular shape.

39. A method as claimed in claim 1, wherein the sealing mixture comprises 1% to 50% sealing elements by weight.

40. A method as claimed in claim 39, wherein the sealing mixture comprises 1 to 30% sealing elements by weight.

41. A method as claimed in claim 1, wherein the leak is a leak in a valve, pipe, vessel or a duct.

42. A method as claimed in claim 1, further comprising the step of using condition monitoring to assess degradation of the seal.

43. (canceled)

44. A sealing mixture comprising:
a non-Newtonian fluid; and
at least one elastomeric sealing element.

45. A sealing mixture as claimed in claim 44, wherein the sealing elements are suspended in the sealing mixture.

46. A sealing mixture as claimed in claim 44, wherein the sealing elements are coated with a non-Newtonian fluid.

47. (canceled)
